(19) United States
(12) Patent Application Publication
(10) Pub. No.: US 2026/0367249 A1
(43) Pub. Date: Nov. 19, 2026

(54) MULTI-CHANNEL ULTRASONIC MEASURING UNIT AND CORRESPONDING METHOD AND COMPUTER PROGRAM PRODUCT

(71) Applicant: Valeo Schalter und Sensoren GmbH, Bietigheim-Bissingen (DE)

(72) Inventors: Maximilian Poepperl, Kronach Neuse (DE); Niko Moritz Scholz, Kronach Neuse (DE); Sebastian Delling, Kronach Neuse (DE)

(73) Assignee: Valeo Schalter und Sensoren GmbH, Bietigheim-Bissingen (DE)

(21) Appl. No.: 19/133,583

(22) PCT Filed: Nov. 22, 2023
(86) PCT No.: PCT/EP2023/082696

§ 371 Date: May 28, 2025

(30) Foreign Application Priority Data
Nov. 28, 2022 (DE) 10 2022 131 308.5

(51) Int. Cl. G01S 15/931; G01S 7/527; G01S 7/536; G01S 15/10

(52) U.S. Cl. CPC G01S 15/931; G01S 7/527; G01S 7/536; G01S 15/102

(57) ABSTRACT

Described is an ultrasonic measuring unit for use in a vehicle. The ultrasonic measuring unit includes a control unit and an analysis unit. The control unit is designed to control an ultrasonic transducer for alternately emitting ultrasonic signals on different channels. The analysis unit is designed to analyze echoes resulting from the ultrasonic signals on the channels for detecting an object causing the echoes.

The invention relates to an ultrasonic measuring unit, in particular for use in a vehicle, to a method for operating an ultrasonic measuring unit and to a corresponding computer program product.

Motor vehicles are increasingly being equipped with ultrasonic sensors which are typically integrated into the bodywork and are intended to assist the driver in detecting obstacles in the path of the motor vehicle in a timely manner, in particular in areas which are difficult for the driver to see, as well as in assessing the distance from obstacles. The operating principle of such an ultrasonic sensor is based on sending out ultrasonic signals and detecting echoes of the emitted ultrasonic signals, which echoes originate from any obstacles located in the detection range of the sensor. The ultrasonic pulses generated for this purpose can have a temporally constant frequency. Furthermore, approaches using a temporally variable frequency (“chirp”) and multiple separate emission and reception channels (e.g. by frequency-division multiplexing) are known.

Ultrasonic sensors are used today in a wide range of applications, from parking aids to assistance systems for dead-spot detection. In the field of autonomous driving in urban environments (“urban driving”), ultrasonic sensors have only been used very little thus far. The reason for this is, on the one hand, the desire for higher-performance systems especially in partially or fully automated driving, but also the limitation of the range in combination with the sampling rate of the ultrasonic sensors, which is limited by the speed of sound.

The speed of sound largely determines the range and the sampling rate of an ultrasonic sensor. As a result, ranges of up to 10 m using ultrasonic sensors are already conceivable today in the automotive sector. Due to the speed of sound, such a measurement using an ultrasonic sensor takes as long as 60 ms under normal conditions. In the best case, 16 measurements per second would thus be possible. If multiple sensors are now used in a system and multiple measurement steps are required to achieve full system coverage, the measurement rate for the complete system typically drops to 5-8 updates per second. Such a low update rate has significant negative consequences for object detection but in particular also for the tracking of objects, which is why this is not usable today.

The object of the invention is to provide an improved ultrasonic measuring unit, with a corresponding method and computer program product. The underlying problems of the invention are solved by the features of the independent claims. Embodiments are specified in the dependent claims.

To solve the problem, the invention provides an ultrasonic measuring unit, in particular for use in a vehicle, which comprises a control unit and an analysis unit, wherein
the control unit is designed to control an ultrasonic transducer for alternately emitting ultrasonic signals on different channels,
the analysis unit is designed to analyze echoes resulting from the ultrasonic signals on the channels for detecting at least one object causing the echoes.

According to the invention, the ultrasonic measuring unit emits ultrasonic signals, such as, for example, ultrasonic pulses, alternately on two or more different channels. In this case, the term “channel” refers to any property of an ultrasonic signal on the basis of which the analysis unit can distinguish an echo of a first ultrasonic signal, which was emitted on a first of the two or more different channels, from an echo of a second ultrasonic signal, which was emitted on another, second of the two or more different channels. Without limitation, such a channel-defining property could comprise a characteristic frequency, a characteristic frequency spectrum, a characteristic temporal frequency curve, a characteristic amplitude and/or a characteristic phase angle at the beginning of the emitting operation of the respective ultrasonic signal.

The ultrasonic measuring unit could use one or more ultrasonic transducers for emitting and receiving. Multiple ultrasonic transducers could be used to emit ultrasonic signals, wherein, however, at least two ultrasonic signals are emitted alternately on different channels on each ultrasonic transducer used for emitting. For example, the emitting ultrasonic transducers could be designed specifically for the implemented two or more channels. Using the same ultrasonic transducer to emit on different channels could enable very efficient obstacle detection with minimal technical effort and material use. In this case, obstacle detection is possible with a high sampling rate.

In principle, some or all of the echoes to be processed by the analysis unit can be received by the same ultrasonic transducer by which the respective original signal of the echoes was emitted. This could also reduce the technical effort and material use required for using multi-channel ultrasound for obstacle detection. However, one or more further ultrasonic transducers could just as well be used to receive an echo of an ultrasonic signal which was emitted by an emitting ultrasonic transducer. Preferably, some or all of the ultrasonic transducers can emit and receive on all implemented channels. However, the available ultrasonic sensors could alternatively be divided into those which emit and/or receive only on a portion of the channels and those which emit and/or receive only on another portion of the channels. In particular, each of the receiving ultrasonic transducers could be assigned to one or more of the channels or be designed to receive on one or more of the channels. Ultrasonic transducers specific to one or more of the channels could differ from each other in terms of design in order to each be able to better meet the specific requirements for the channels implemented for each ultrasonic transducer. For example, different frequency ranges could correspond to the channels, and the ultrasonic transducers working on different frequency ranges could be optimized accordingly for maximum efficiency for conversion in the respective frequency range.

Use could also be made of ultrasonic transducers which are specifically designed to emit ultrasonic signals or specifically designed to receive echoes having smaller amplitudes than original ultrasonic signals underlying the echoes. Emitting and receiving transducers can differ from each other in terms of design in order to each individually better meet the specific requirements of emitting and receiving. For example, an emitting ultrasonic transducer could be designed to produce the ultrasonic signals with a large amplitude as distortion-free as possible, while a receiving ultrasonic transducer could be designed to detect the echoes of the ultrasonic signals with the highest possible sensitivity in a low-noise manner.

The control unit and the analysis unit could be implemented as different units or assemblies which work independently of each other in terms of signal transfer. Alternatively, the control unit and the analysis unit could be integrated into the same assembly or unit. For example, the control unit and the analysis unit could be realized by means of analog or digital electronics, in particular in the form of one or more integrated circuits. The control unit and the analysis unit could also be implemented as software modules which are executed on a generic or specialized processor, in particular a central processing unit (CPU). One or more communication channels can be implemented between the control unit and the analysis unit, which one or more communication channels allow transmission of signals between the two said units which goes beyond the emitting of ultrasonic signals and the receiving of echoes of these emitted ultrasonic signals.

Preferably, the control unit controls an ultrasonic transducer by outputting an electrical signal. The ultrasonic transducer could then be designed to convert between electrical energy and mechanical vibrations. For example, an ultrasonic transducer could have a membrane which is excited by a piezoelement to emit an ultrasonic signal or, when receiving an ultrasonic signal, is set into acoustic oscillations and transmits the latter to the piezoelement. The electrical signal which is output by the piezoelectric element and which corresponds to a received ultrasonic signal could then be received and analyzed by the analysis unit.

According to one embodiment, the control and analysis take place in a measuring cycle, wherein the measuring cycle is performed cyclically repeatedly. In particular, a change in the distance between the emitting ultrasonic transducer and an obstacle could thus be able to be detected. As the following explanations show in detail, the alternating emission of ultrasonic signals on different channels could not only effectively increase the detection rate for obstacles but in particular also allow measurement of multiple distance ranges (e.g. a near range of up to 5 m and a far range of 5 to 10 m) quasi simultaneously with a high or optimized sampling rate for the near range. In particular, cyclical repetition of the measuring cycle could allow echoes to be received from ultrasonic signals which were emitted in an earlier measuring cycle. In this way, e.g., continuous detection of obstacles within the detection range with a high sampling rate is possible.

According to one embodiment, within the measuring cycle the ultrasonic signals comprise at least a first ultrasonic signal on a first channel and a second ultrasonic signal on a second channel. The ultrasonic measuring unit will thus firstly send out a first ultrasonic signal on a first channel. Subsequently, during a predefined first reception period, the ultrasonic measuring unit can receive echoes originating from the first ultrasonic signal. Owing to the immediate temporal proximity to the emitting of the first ultrasonic signal, the echoes received during this first reception period originate from an obstacle reflection from a “near range” relative to the ultrasonic transducer.

After the first reception period, but still always in the same measuring cycle, the ultrasonic measuring unit will send out a second ultrasonic signal on a second channel. In this case, the second channel is different from the first channel. Subsequently, during a predefined second reception period, the ultrasonic measuring unit can receive echoes of the second ultrasonic signal which again originate from the near range but are received on the second channel.

According to one embodiment, the analysis takes into account at least echoes resulting on the first channel between the emitting of the two ultrasonic signals and the analysis takes into account echoes resulting on the first and the second channel after the emitting of the second ultrasonic signal. Within the second reception period, the ultrasonic measuring unit can thus additionally receive on the first channel echoes of the first ultrasonic signal previously emitted on the first channel. Since the echoes received during the second reception period have already propagated over the duration of the first reception period and the duration of the emitting of the second ultrasonic signal, they provide information about obstacles which scatter the first ultrasonic signal back to an ultrasonic transducer connected to the ultrasonic measuring unit from a greater distance corresponding to this longer propagation duration.

If the entire measuring cycle is thus considered, it is possible to detect obstacles in the near range and in the far range using the individual emitting ultrasonic transducer within the measuring cycle, wherein, e.g., the sampling rate in the near range is twice as high as for the far range. In this way, in addition to the two measurements in the near range, a measurement in a far range can also be performed in the second reception period without limiting the repetition rate.

E.g., the ultrasonic measuring unit is designed for simultaneous reception of echoes of ultrasonic signals on at least two channels (the above-mentioned channels), wherein there is as little pause as possible between two measurements and the measurement times are precisely known. In particular, it could be advantageous if the channels have a low “coupling”, that is to say if the emission of the second ultrasonic signal on the second channel does not affect the reception of echoes on the first channel. In this case, the ultrasonic measuring unit could continue to receive echoes of the first ultrasonic signal on the first channel even while emitting the second ultrasonic signal and so there is no “blind area” between the echoes from the near range and the echoes from the far range. Such a blind area would correspond to a spatial area in which no obstacle can be detected (“blind spot”).

The above example illustrates the basic ideas of the invention on the basis of ultrasonic signals which are emitted and received on two channels. Of course, the ultrasonic measuring unit could, however, also emit more than two ultrasonic signals on more than two different channels. It could also be designed to receive echoes of the ultrasonic signals emitted on the channels. In this way, the spatial detection range of the ultrasonic measuring unit could be divided into more than two distance ranges. In the case of a three-channel ultrasonic measuring unit, for example, there could firstly be a near range from which echoes of the ultrasonic signals are received on all three channels within a single measuring cycle. Furthermore, there may be a mean distance range from which echoes are received on the first two channels within the same measuring cycle. Finally, in this case, there may also be a far range from which only echoes of the earliest emitted first ultrasonic signal are received on the first channel within the same measuring cycle. The concept can readily be transferred to any other number of channels for each measuring cycle.

According to one embodiment, a maximum spatial measuring distance for the ultrasonic measuring unit is defined, wherein the length of the measuring cycle is set such that an echo resulting from the first ultrasonic signal and which is caused by a reflection from an object located at the maximum measuring distance can be detected within the measuring cycle. The maximum spatial measuring distance (referred to herein as the range) is the maximum distance within which a detectable obstacle can be located. An echo resulting from this furthest obstacle is thus able to be detected during the measuring cycle. It results from the earliest emitted ultrasonic signal during this measuring cycle.

An ultrasonic signal emitted by an ultrasonic transducer propagates at a speed of sound of typically c≈343 m/s. Within a time t, the ultrasonic signal covers the distance x=ct. For an obstacle located at a distance, this results in a delay time of the ultrasonic signal of Δt=2 L/c between the emission of the ultrasonic signal and the sensing of the echo from the distance L. For a cycle duration T, this gives a maximum spatial measuring distance of Lₘₐₓ=cT/2. If, e.g., a range of 10 m is desired, this thus requires a cycle duration of 60 ms within a tolerance of, e.g., 5%.

In the case of an alternating emission on N channels, the cycle duration is divided into T/N sub-intervals, each of which has an emission period for emitting on one of the N channels and a reception period for receiving echoes. The echoes of ultrasonic signals received in a second or later sub-interval, which ultrasonic signals were emitted in a previous sub-interval, could result in a greater range (e.g. a doubled range when using two channels) compared to a single-channel ultrasonic measuring unit with a cycle duration T_{1K}=T_{2K}/N for the multi-channel ultrasonic measuring unit disclosed herein, without having to worry about limitations in the measuring rate for the near range.

It should be noted that, compared to a single-channel ultrasonic measuring unit with the same cycle duration T_{1K}=T_{2K}, the multi-channel ultrasonic measuring unit disclosed herein could monitor closer sections (distance ranges) of the detection range defined by the range, that is to say, e.g., the near range, with a higher sampling rate than more distant sections (distance ranges) of the detection range (e.g., the far range). This is because the ultrasonic measuring unit does not need to wait until the beginning of a new measuring cycle before a new ultrasonic signal which allows monitoring of the near range is sent out. Instead, it can use the delay time of the echoes from the farther distance ranges to emit ultrasonic signals on other channels in order to achieve higher frequency monitoring of the near range.

For the example of a two-channel ultrasonic measuring unit preferably used herein without limitation to simplify the illustration, this means that both objects in the near range can be detected, and objects in the far range can be identified early. This could lead to possible applications, in particular in urban areas. For example, the ultrasonic measuring unit could be used in a motor vehicle to ascertain whether a turning lane is occupied or not. The larger range of the ultrasonic measuring unit could allow this function even if this turning lane is more than one lane away from the currently used lane. Especially for the near range, a high sampling rate, as made possible by the invention, will be particularly relevant. Here, short-term distance changes to an obstacle can have an impact with a greater risk than for the far range.

According to one embodiment, the analysis unit is designed to analyze echoes resulting from the ultrasonic signals continually on all the channels within the measuring cycle. In this way, the analysis unit could analyze echoes (originating from the previous measuring cycle) in a repetition of the measuring cycle on a given channel at any time, but in particular also in an “early” reception period. In this way, a farther distance range within the range of the ultrasonic measuring unit could be continuously monitored at the same measuring rate as a distance range nearer to the emitting ultrasonic transducer. The delay time of the echo received on the given channel before it is emitted again can be reconstructed from the reception time and the characteristics of the channel on which the echo was received, if the emission scheme is known (i.e. in which sub-interval of a given measuring cycle and on which channel the emission takes place).

According to one embodiment, the analysis unit is designed to receive the echoes from the same ultrasonic transducer from which the ultrasonic signals were emitted. In contrast to an ultrasonic measuring unit having different transducers for emitting and receiving, it could thus be sufficient to equip the ultrasonic measuring unit with a single ultrasonic transducer. As a result, a simpler design of the ultrasonic measuring unit with a lower material use could be achieved.

According to one embodiment, the different channels comprise at least three channels, wherein within the measuring cycle the emitting of the successive ultrasonic signals takes place at different time intervals, wherein the different time interval for the cyclically repeated performance of the measuring cycle is constant. Within a given first measuring cycle, ultrasonic signals emitted successively on a first pair of channels are emitted at a time interval t₁. The time interval t₁ is different from a time interval t₂ in which successive ultrasonic signals are emitted on another, second pair of channels within the same measuring cycle. The proviso that the different time interval for the cyclically repeated performance of the measuring cycle is constant means that in another, second measuring cycle, the ultrasonic signals emitted on the first pair of channels are emitted at the same time interval as correspondingly previously in the first measuring cycle. As a result of this, the above-described spatial area of the “blind spot” can be minimized or even eliminated.

During the emission of an ultrasonic signal, it could happen that the analysis unit cannot detect echoes of a first ultrasonic signal in a second emission period within which a second ultrasonic signal following the first ultrasonic signal is emitted (“blind area, blind spot”). While the emission is being carried out and, if necessary, also still subsequently due to reverberation of the membrane of the ultrasonic transducer, the detection capability of this same transducer may be reduced or even prevented. Thus, the duration of the actual “emission period” of an ultrasonic signal can, e.g., extend significantly beyond the duration of the actual control signal which causes the excitation force, due to the reverberation of the ultrasonic transducer after the excitation force has ceased.

As already explained above, using at least three channels by alternating emission can allow a temporal division of the measuring cycle into at least three corresponding sub-intervals and a corresponding division of the spatial detection range for obstacles into at least three distance ranges corresponding to the temporal sub-intervals. If the time intervals between two emission operations are now varied from measuring cycle to measuring cycle, the size of the undetectable, “blind” distance range at the transition between two adjacent distance ranges can thus be reduced overall.

According to one embodiment, during the cyclically repeated performance of the measuring cycle the emitting of the successive ultrasonic signals takes place at a different time interval at least for some of the measuring cycles. If, for example, in the case of two measuring cycles the time at which the respective second ultrasonic signal is emitted is varied by a time difference +Δt or −Δt, the ultrasonic transducer can thus additionally receive echoes of ultrasonic signals in one of the measuring cycles even during the period Δt in which a new ultrasonic signal would otherwise already have been emitted. Compared to dividing the measuring cycle into equally long sub-intervals, this reduces the area of any “blind spots”. For example, the relative variation of the time interval for a given pair of channels used for successively emitting ultrasonic signals in different measuring cycles is at least 3%, preferably at least 5%.

According to one embodiment, the ultrasonic measuring unit further comprises the ultrasonic transducer, wherein the ultrasonic transducer is designed to receive the echoes resulting from the ultrasonic signals on all channels and to transmit them to the analysis unit. This does not exclude the ultrasonic measuring unit from being able to have more than one ultrasonic transducer. In the case where the ultrasonic measuring unit has more than one ultrasonic transducer, it is in turn implied that echoes detected by a given ultrasonic transducer do not necessarily have to originate from ultrasonic signals which were emitted by the same ultrasonic transducer.

In a further aspect, the invention provides a method for operating an ultrasonic measuring unit, in particular for use in a vehicle, wherein the ultrasonic measuring unit comprises a control unit and an analysis unit, wherein the method comprises:
controlling, by way of the control unit, an ultrasonic transducer for alternately emitting ultrasonic signals on different channels,
analyzing, by way of the analysis unit, echoes resulting from the ultrasonic signals on the channels for detecting at least one object causing the echoes.

In a further aspect, the invention provides a computer program product, in particular a computer-readable storage medium, wherein the computer program product comprises computer-executable code, wherein the code is able to be executed by at least one processor of a computer device to cause the computer device to perform the method disclosed herein.

The person skilled in the art will understand that aspects of the present invention may be implemented as an apparatus, method or computer program or computer program product. Accordingly, aspects of the present invention may take the form of a pure hardware embodiment, a pure software embodiment (including firmware, in-memory software, microcode, etc.), or an embodiment combining software and hardware aspects, which may all be generally referred to as a “circuit”, “module” or “system” herein. Furthermore, aspects of the present invention may take the form of a computer program product which is carried by a computer-readable medium or by multiple computer-readable media in the form of computer-executable code. A computer program likewise comprises the computer-executable code. “Computer-executable code” may also be referred to as “computer program instructions”.

Any combination of one or more computer-readable media may be used. The computer-readable medium may be a computer-readable signal medium or a computer-readable storage medium. A “computer-readable storage medium”, as used herein, comprises a material storage medium which can store instructions which are able to be executed by a processor of a computer device. The computer-readable storage medium may be referred to as a computer-readable non-volatile storage medium. The computer-readable storage medium may also be referred to as a tangible computer-readable medium. In some embodiments, a computer-readable storage medium may also be capable of storing its data which allows it to be accessed by the processor of the computer device. Examples of computer-readable storage media include, but are not limited to: a floppy disk, a magnetic hard disk, a solid-state hard disk, flash memory, a USB key, Random-Access Memory (RAM), Read-Only Memory (ROM), an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW or DVD-R disks. The term computer-readable storage medium also refers to various types of recording media which are suitable for being retrieved from the computer device via a network or a communication connection. For example, data can be retrieved via a modem, via the Internet or via a local network. Computer-executable code executed on a computer-readable medium may be transmitted via any suitable medium, including, but not limited to, wireless, wired, fiber optic cables, RF, etc., or any suitable combination of the above media.

A computer-readable signal medium may include a propagated data signal which contains the computer-readable program code, for example, in a basic signal (baseband) or as part of a carrier signal (carrier wave). Such a propagation signal may be formed in any form, including, but not limited to, an electromagnetic form, an optical form, or any suitable combination thereof. A computer-readable signal medium may be any computer-readable medium which is not a computer-readable storage medium and which can transmit, distribute or transport a program for use by or in connection with a system, apparatus or device for executing instructions.

“Computer memory” or “memory” is an example of a computer-readable storage medium. A computer memory is any memory which is directly accessible to a processor.

“Computer data store” or “data store” is another example of a computer-readable storage medium. A computer data store is any non-volatile computer-readable storage medium. In some embodiments, a computer memory may also be a computer data store or vice versa.

A “processor”, as used herein, comprises an electronic component which is capable of executing a program-or machine-executable instruction or computer-executable code.

Reference to the computer device comprising a “processor” should be interpreted as possibly comprising more than one processor or processing cores. The processor may, for example, be a multi-core processor. A processor may also refer to a collection of processors within a single computer system or distributed across multiple computer systems. The term computer device or computer should also be interpreted as possibly referring to a collection or a network of computer devices or computers, each comprising a processor or processors. The computer-executable code may be executed by multiple processors which may be distributed within the same computer device or even across multiple computers.

Computer-executable code may include machine-executable instructions or a program which causes a processor to perform an aspect of the present invention. Computer-executable code for performing operations for aspects of the present invention may be written in any combination of one or more programming languages, including an object-oriented programming language such as Java, Smalltalk, C++ or similar and conventional method-oriented programming languages such as the programming language “C” or similar programming languages, and translated into machine-executable instructions. In some cases, the computer-executable code may be in the form of a higher-level programming language or in a pre-translated form, and may be used in conjunction with an interpreter which generates the machine-executable instructions.

The computer-executable code may be executed completely on the computer of a user, partly on the computer of the user, as a stand-alone software package, partly on the computer of the user and partly on a remotely located computer, or completely on the remotely located computer or server. In the latter case, the remotely located computer may be connected to the computer of the user by any type of network, including a local area network (LAN) or a wide area network (WAN), or the connection may be made to an external computer (for example, over the Internet using an Internet service provider).

The computer program instructions may be executed on one processor or on multiple processors. In the case of multiple processors, these may be distributed across multiple different entities (e.g. clients, servers). Each processor could execute a portion of the instructions intended for the respective entity. Thus, if a system or method which comprises multiple entities is mentioned, the computer program instructions are thus understood to be adapted to be executed by a processor assigned or belonging to the respective entity.

Aspects of the present invention are described with reference to flowchart illustrations and/or block diagrams of methods, devices (systems) and computer program products according to embodiments of the invention. It is pointed out that each block or parts of the blocks of the flowcharts, illustrations and/or the block diagrams can be executed by computer program instructions, possibly in the form of a computer-executable code. It is also pointed out that combinations of blocks in different flowcharts, illustrations and/or block diagrams can be combined if they are not mutually exclusive. These computer program instructions may be provided to a processor of a universal computer, special computer or another programmable data processing device to produce a device such that the instructions executed by the processor of the computer or the other programmable data processing device produce means for executing the functions/steps specified in the block or the blocks of the flowcharts and/or the block diagrams.

These computer program instructions may also be stored on a computer-readable medium which can control a computer or other programmable data processing devices or other devices to operate in a certain manner such that the instructions stored on the computer-readable medium produce a manufactured product, including instructions which implement the function/step specified in the block or the blocks of the flowcharts and/or the block diagrams.

The computer program instructions may also be stored on a computer, other programmable data processing devices or other devices to cause the execution of a series of process steps on the computer, other programmable data processing devices or other devices to produce a process executed on a computer such that the instructions executed on the computer or the other programmable devices produce methods for implementing the functions/steps specified in the block or the blocks of the flowcharts and/or the block diagrams.

Further advantages and features arise from the following description in conjunction with the attached drawings. In said drawings:

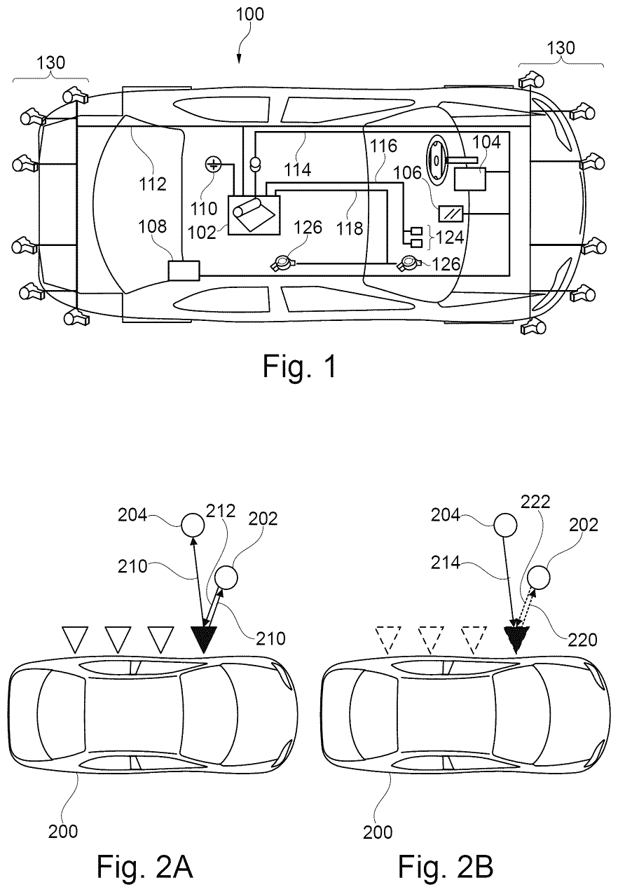

FIG. 1 shows a motor vehicle equipped with an ultrasonic measuring unit,

FIG. 2A shows an emission and reception operation on a first channel of an ultrasonic measuring unit,

FIG. 2B shows an emission operation on a second channel and a reception operation on a first and a second channel of an ultrasonic measuring unit,

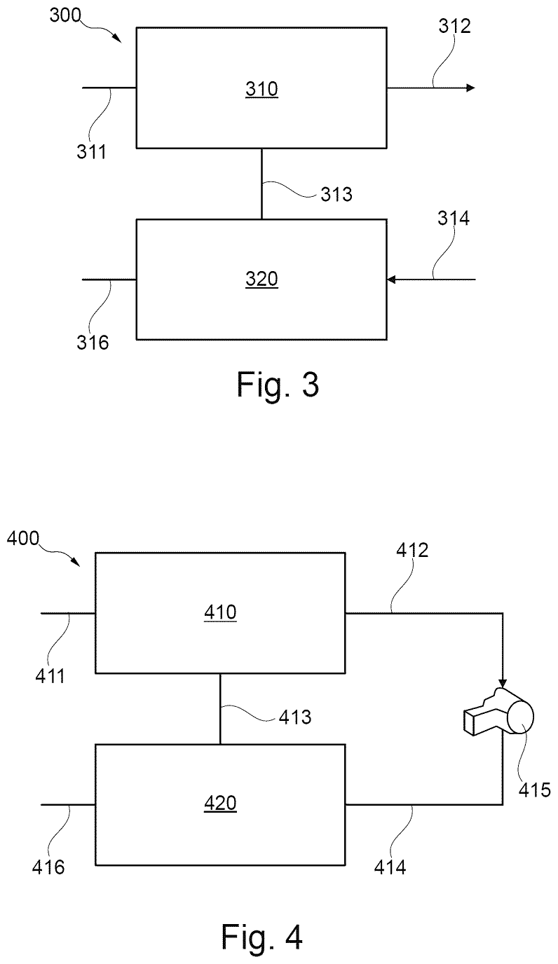

FIG. 3 shows a block diagram of components of an ultrasonic measuring unit,

FIG. 4 shows a block diagram of components of an ultrasonic measuring unit,

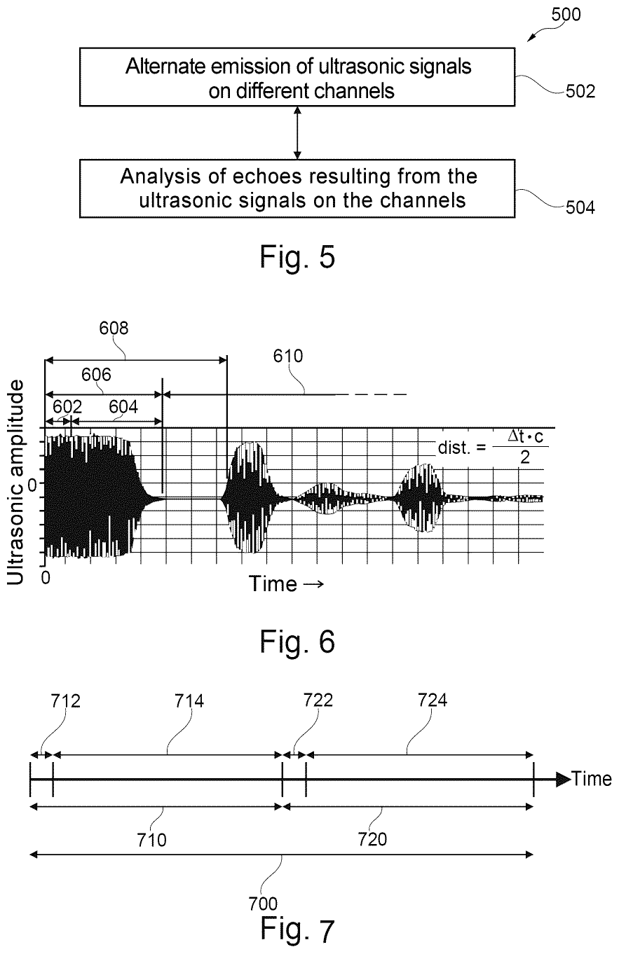

FIG. 5 shows a flowchart of a method for operating an ultrasonic measuring unit,

FIG. 6 shows a time diagram of an ultrasonic amplitude measured on an ultrasonic transducer on a channel, and

FIG. 7 shows an illustration of a temporal division of a measuring cycle.

In particular in automotive technology, ultrasonic measuring systems are increasingly being used to detect obstacles and measure their distance. FIGS. 2A and 2B show, by way of example, the alternate emission of ultrasonic signals 210, 220 on different channels and the reception of echoes 212, 214, 222 of the emitted ultrasonic signals 210, 220. The ultrasonic measuring unit 300 illustrated in FIG. 3 or the ultrasonic measuring unit 400 illustrated in FIG. 4 could be used for this purpose. An ultrasonic measuring unit 300, 400 could implement the method 500 illustrated in FIG. 5 for operating an ultrasonic measuring unit in order to detect objects 202, 204 in the vicinity of, e.g., a motor vehicle 100, 200. For this purpose, ultrasonic signals 210, 220 can be emitted in the direction of the objects 202, 204, the echoes 212, 214, 222 of which are received and analyzed on the basis of the time and the channel of the reception.

FIG. 1 shows a motor vehicle 100, for example a ground-based motor vehicle such as, for instance, a passenger car, a goods transport vehicle (van, truck) or an agricultural vehicle. In the non-limiting example of FIG. 1, the motor vehicle 100 has an electronic controller unit 102 which could implement the control unit and the analysis unit of an ultrasonic measuring unit as functions. To illustrate these functions, the controller unit 102 could, for example, have a specialized chip which has program instructions permanently programmed therein which the chip executes to cause the controller unit 102 to realize the functions of the control unit and the analysis unit; or the controller unit 102 could, for example, have a generic processor which, when the controller unit 102 is initialized, loads program instructions from a memory, which the processor executes to cause the controller unit 102 to perform the functions of the control unit and the analysis unit. A power source 110 (e.g. a battery and/or an alternator) of the motor vehicle 100 could provide electrical energy in order to be able to use the components connected to the controller unit 102 as described below.

The motor vehicle 100 has a plurality of ultrasonic transducers 130 which are connected to an interface of the controller unit 102 via an, e.g., analog or digital electrical line system 112. Via the line system 112, the controller unit 102 could perform the function of the control unit to control one or more of the ultrasonic transducers 130 for alternately emitting ultrasonic signals on different channels. Echoes of the emitted ultrasonic signals, received by one or more of the ultrasonic transducers 130, could be converted into electrical signals by the ultrasonic transducers 130 and transmitted to the controller unit 102 via the line system 112. The controller unit 102 could perform the function of the analysis unit to analyze the signals corresponding to the received echoes for detecting at least one object causing the echoes.

Further components of the motor vehicle 100 could be connected to the interface of the controller unit 102. For example, a bus system 114 (e.g. a controller area network, CAN) could connect a steering controller 104, a human-machine interface 106 (e.g. a touch-screen display) and a brake controller 108 to the controller unit 102. The controller unit 102 could be designed to generate and/or adapt signals intended for the steering controller 104, the human-machine interface 106 and/or the brake controller 108 on the basis of an analysis result of the ultrasonic echoes, provided by the analysis unit, and/or to control and/or adapt the function of the control unit and/or the analysis unit in response to a user interaction with the human-machine interface 106. In a further example, an, e.g., analog or digital electrical line system 116, 118 could connect a set of operating elements 124 and a set of output units 126 (e.g. loudspeakers) to the controller unit 102. The controller unit 102 could be designed to generate and/or adapt signals intended for the output units 126 on the basis of an analysis result of the ultrasonic echoes, provided by the analysis unit, and/or to control and/or adapt the function of the control unit and/or the analysis unit in response to a user interaction with the operating elements 124.

FIG. 2 shows a schematic illustration of snapshots of a motor vehicle 200 with an ultrasonic measuring unit at different times of emitting ultrasonic signals 210, 220 and receiving echoes 212, 214, 222 of the emitted ultrasonic signals. In FIG. 2A, the ultrasonic measuring unit has caused an ultrasonic transducer to emit a first ultrasonic signal 210 on a first channel, e.g. at a first frequency. There are two obstacles in the detection range from which the ultrasonic measuring unit can receive echoes of ultrasonic signals via one or more ultrasonic transducers within the limits specified by the measurement sensitivity and, where appropriate, the duration of a measuring cycle. The obstacle 204 has a greater distance from the motor vehicle 200 than the obstacle 202.

At the time illustrated in FIG. 2A, the first ultrasonic signal 210 has propagated to the nearest obstacle 202 and to the farthest obstacle 204 and a first echo 212 of the first ultrasonic signal 210, reflected back from the nearest obstacle 202 in the direction of the motor vehicle 200, has just reached one of the ultrasonic transducers. At the time of FIG. 2A, the analysis unit can thus detect the obstacle 202 by analyzing a signal corresponding to the first echo 212 of the first ultrasonic signal 210. In FIG. 2A, no ultrasonic echo has yet to be reflected from the obstacle 204 in the direction of the motor vehicle 200.

FIG. 2B shows the motor vehicle 200 and the obstacles 202, 204 at a later time. In FIG. 2B, the ultrasonic measuring unit has caused the same ultrasonic transducer to emit a second ultrasonic signal 220 on a second channel, e.g. at a second frequency. The two obstacles 202, 204 are still in the detection range of the ultrasonic measuring unit and the obstacle 204 still has a greater distance from the motor vehicle 200 than the obstacle 202. At the time illustrated in FIG. 2B, the second ultrasonic signal 220 has been reflected from the nearest obstacle 202 (echo 222). At the time of FIG. 2B, the analysis unit can thus detect the obstacle 202 by analyzing a signal corresponding to the echo 222.

In FIG. 2B, the ultrasonic signal 210 from the obstacle 204 has meanwhile also been reflected as a second echo 214. At the time illustrated in FIG. 2B, the analysis unit can thus detect the obstacle 204 by analyzing a signal corresponding to the second echo 214. This principle described with respect to a single ultrasonic transducer can also be correspondingly transferred to multiple ultrasonic transducers, as shown schematically in the form of triangles in FIGS. 2A and 2B.

FIG. 3 shows a block diagram of an exemplary ultrasonic measuring unit 300. The ultrasonic measuring unit 300 has a control unit 310 and an analysis unit 320. The control unit 310 has an output via which the control unit 310 can emit a signal 312 to one or more ultrasonic transducers, which signal causes the one or more ultrasonic transducers to in each case alternately emit ultrasonic signals on different channels. The control unit 310 may have an interface for connecting to a signal line 311 via which the control unit 310 can exchange signals (e.g. signals for controlling and/or configuring functions of the control unit 310, signals for transmitting outputs of the control unit 310, such as, e.g., status information, etc.) with other units. The control unit 310 may also have an interface for connecting to a signal line 313 via which the control unit 310 can exchange signals (e.g. time synchronization signals, trigger signals or other control signals) with the analysis unit 320. The analysis unit 320 has an input via which the analysis unit 320 can receive a signal 314 from one or more ultrasonic transducers, which signal corresponds to an ultrasonic signal received by the one or more ultrasonic transducers (e.g. an echo of the ultrasonic signals). The analysis unit 320 may further have an interface for connecting to a signal line 316 via which the analysis unit 320 can exchange signals (e.g. signals for controlling and/or configuring functions of the analysis unit 320, signals for transmitting outputs of the analysis unit 320, such as, e.g., status information and/or information about obstacles detected by means of the received signals, such as, for instance, a distance of an obstacle located nearest to the emitting ultrasonic transducer, etc.) with other units. The analysis unit 320 may also have an interface for connecting to the signal line 313 via which the analysis unit 320 can exchange signals (e.g. time synchronization signals, trigger signals or other control signals) with the control unit 310.

FIG. 4 shows a block diagram of an ultrasonic measuring unit 400. The ultrasonic measuring unit 400 has a control unit 410, an analysis unit 420 and one or more ultrasonic transducers 415, as used, e.g., in FIGS. 2A and 2B. The control unit 410 has an output via which the control unit 410 can emit a signal 412 to one or more of the ultrasonic transducers 415, which signal causes the one or more ultrasonic transducers 415 to in each case alternately emit ultrasonic signals on different channels. The configuration of the control unit 410 and the analysis unit 420 including signal line 411, interface 413 and signal line 416 can correspond to FIG. 3 (reference signs 310, 320, 311, 313 and 316 therein).

The analysis unit 420 has an input via which the analysis unit 420 can receive a signal 414 from one or more of the ultrasonic transducers 415, which signal corresponds to an ultrasonic signal received by the ultrasonic transducer 415 (e.g. an echo of the ultrasonic signals). The one or more ultrasonic transducers 415 may have an interface for receiving a signal 412 from the control unit 410 and for emitting a signal 414 to the analysis unit 420, a transmitter device for generating ultrasonic signals on the basis of the received signal 412 and, e.g., a receiver device for amplifying received ultrasonic signals and generating the signal 414 on the basis of the received ultrasonic signals.

FIG. 5 shows a flowchart with steps of a method 500, as can be implemented by an ultrasonic measuring unit disclosed herein. The method 500 makes provision for the ultrasonic measuring unit to control 502, by means of its control unit, one or more ultrasonic transducers in order to in each case alternately emit ultrasonic signals on different channels. The method 500 further has a step 504 in which the analysis unit of the ultrasonic measuring unit analyzes signals which result from the echoes resulting from ultrasonic signals alternately emitted on the different channels, in order to detect at least one object causing the echoes. Successful performance of step 504 requires step 502 to have been performed at least once previously in order to generate potential echoes which can be analyzed by the analysis unit. Apart from that, steps 502, 504 can be performed, repeated and/or temporally parallelized in any order.

FIG. 6 shows a diagram of an exemplary time characteristic of the signal amplitude measured by an ultrasonic transducer at the beginning of an emission and reception period on a single channel. The time and duration values mentioned in connection with FIG. 6 are used for illustrative purposes only and are in no way to be understood as specifications for limiting the invention. The emission and reception period begins with excitation of the vibration unit (e.g. the membrane) of the ultrasonic transducer to emit an ultrasonic signal at the time t=0. The excitation signal which is output by the control unit of the ultrasonic measuring unit and which causes the excitation unit (e.g. the piezo element) of the ultrasonic transducer to excite the vibration unit from t=0 is terminated after a predefined excitation duration 602 (e.g. 250 μs) has elapsed. After the excitation signal has been terminated, the vibration unit continues to vibrate for a reverberation duration 604 with a known nominal value (e.g. 1 ms) until the measured amplitude falls below a known or continuously updated noise level. The sum of the excitation duration 602 and the reverberation duration 604 forms the emission period 606 for the given channel (e.g. 1.25 ms). The emission period 606 is followed by a reception period 610 the duration of which (e.g. 30 ms) is large compared to the duration of the emission period and the end of which is therefore not illustrated in FIG. 6. During the reception period 610, emission operations are not intended on any of the channels implemented by the ultrasonic measuring unit. The emission period 606 and the reception period 610 are collectively referred to as the emission and reception period.

At a time (illustrated as delay time 608 from t=0) after the end of the emission period 606, a first echo of the ultrasonic signal emitted during the emission period 606 arrives at the ultrasonic transducer. It causes an increase in amplitude which the analysis unit of the ultrasonic measuring unit detects, e.g., by comparing with a predefined threshold value representing a maximum acceptable noise level. From the delay time Δt 608 and the speed of sound c, the analysis unit can determine the distance d=cΔt/2 of the obstacle which has caused the echo received after the delay time 608.

FIG. 7 shows a timeline on which different time periods of a measuring cycle 700 are marked. The measuring cycle 700 is divided into a first emission and reception period 710 and a second emission and reception period 720. In the example of FIG. 7, but without limitation to the generality, the first emission and reception period 710 and the second emission and reception period 720 are of the same length. The first emission and reception period 710 is divided into a first emission period 712 and a first reception period 714; the second emission and reception period 720 is divided into a second emission period 722 and a second reception period 724. In the example of FIG. 7, but without limitation to the generality, the first emission period 712 and the second emission period 722 are of the same length and the first reception period 714 and the second reception period 724 are of the same length. In another, non-limiting example, the measuring cycle 700 has a duration of 50 ms divided into a first emission period of 1.4 ms, a first reception period of 23.6 ms, a second emission period of 1.4 ms and a second reception period of 23.6 ms.

The measuring cycle 700 can be repeated with the same or other durations of the individual emission periods and reception periods. The ultrasonic measuring unit implementing the measuring cycle 700 is configured to control the ultrasonic transducer for alternately emitting ultrasonic signals on different channels. In the example shown in FIG. 7, the ultrasonic measuring unit controls, by means of its control unit, the ultrasonic transducer during the first emission period 712 for emitting a first ultrasonic signal on a first channel and during the second emission period 722 for emitting a second ultrasonic signal on a second channel.

Analogously to the description of FIG. 6, in the first reception period 714, the analysis unit of the ultrasonic measuring unit can analyze, on the first channel, signals which correspond to echoes, received by an ultrasonic transducer, of the first ultrasonic signal emitted during the first emission period 712, in order to detect one or more objects causing the echoes in a near range. Optionally, the analysis unit additionally analyzes, during the first reception period 714, signals which correspond to echoes, received by an ultrasonic transducer, of a second ultrasonic signal emitted during the second emission period 722 of an earlier measuring cycle 700 on the second channel, in order to detect one or more further objects causing the echoes in a first far range. Also optionally, the analysis unit additionally analyzes, during the first reception period 714, signals which correspond to echoes, received by an ultrasonic transducer, of a first ultrasonic signal emitted during the first emission period 712 of an earlier measuring cycle 700 on the first channel, in order to detect one or more further objects causing the echoes in a second far range which is further away from the emitting ultrasonic transducer than the first far range. The analysis unit can distinguish between echoes incoming on the same channel from an earlier measuring cycle 700 with a known time characteristic of the maximum amplitude of ultrasonic echoes on the basis of their maximum amplitude and echoes incoming on the same channel from ultrasonic signals emitted during the current measuring cycle 700.

During the second reception period 724, the analysis unit of the ultrasonic measuring unit analyzes, on the second channel, signals which correspond to echoes, received by an ultrasonic transducer, of the second ultrasonic signal emitted during the second emission period 722, in order to detect one or more objects causing the echoes in a further near range. In addition, the analysis unit analyzes, during the second reception period 724, signals which correspond to echoes, received by an ultrasonic transducer, of a first ultrasonic signal emitted during the first emission period 712 of the current measuring cycle 700 on the first channel, in order to detect one or more further objects causing the echoes in a further first far range. Optionally, the analysis unit additionally analyzes, during the second reception period 724, signals which correspond to echoes, received by an ultrasonic transducer, of a second ultrasonic signal emitted during the second emission period 722 of an earlier measuring cycle 700 on the second channel, in order to detect one or more further objects causing the echoes from a further second far range. The end of the second reception period 724 can be followed by a new measuring cycle 700 having a further first emission period 712.

It should be noted that the embodiments of the invention described herein can be combined with one another in any way, so long as the combination of two particular embodiments is not precluded for technical reasons.

### LIST OF REFERENCE SIGNS

100 motor vehicle
102 controller unit
104 steering controller
106 human-machine interface
108 brake controller
110 power source
112 line system
114 bus system
116 line system
118 line system
124 operating element
126 output unit
130 ultrasonic transducer
200 motor vehicle
202 obstacle
204 obstacle
210 first ultrasonic signal
212 first echo of the first ultrasonic signal
214 second echo of the first ultrasonic signal
220 second ultrasonic signal
222 echo of the second ultrasonic signal
300 ultrasonic measuring unit
310 control unit
311 signal line
312 outgoing signal
313 signal line
314 incoming signal
316 signal line
320 analysis unit
400 ultrasonic measuring unit
410 control unit
411 signal line
412 outgoing signal
413 signal line
414 incoming signal
415 ultrasonic transducer
416 signal line
420 analysis unit
500 method for operating an ultrasonic measuring unit
502 control for emitting
504 analyze for detecting
602 excitation time
604 reverberation time
606 emission period
608 delay time
610 reception period
700 measuring cycle
710 first emission and reception period
712 first emission period
714 first reception period
720 second emission and reception period
722 second emission period
724 second reception period

1. An ultrasonic measuring unit for use in a vehicle, comprising:
a control unit; and
an analysis unit, wherein
the control unit is designed to control an ultrasonic transducer for alternately emitting ultrasonic signals on different channels, and
the analysis unit is designed to analyze echoes resulting from the ultrasonic signals on the channels for detecting at least one object causing the echoes.

2. The ultrasonic measuring unit as claimed in claim 1, wherein the control and analysis take place in a measuring cycle, wherein the measuring cycle is performed cyclically repeatedly.

3. The ultrasonic measuring unit as claimed in claim 2, wherein within the measuring cycle the ultrasonic signals comprise at least a first ultrasonic signal on a first channel and a second ultrasonic signal on a second channel.

4. The ultrasonic measuring unit as claimed in claim 3, wherein the analysis takes into account at least echoes resulting on the first channel between the emitting of the first and second ultrasonic signals and the analysis takes into account echoes resulting on the first and the second channel after the emitting of the second ultrasonic signal.

5. The ultrasonic measuring unit as claimed in claim 3, wherein a maximum spatial measuring distance for the ultrasonic measuring unit is defined, wherein the length of the measuring cycle is set such that an echo resulting from the first ultrasonic signal and caused by an object located at the maximum measuring distance is detected within the measuring cycle.

6. The ultrasonic measuring unit as claimed in claim 2, wherein the analysis unit is designed to analyze echoes resulting from the ultrasonic signals continually on all the channels within the measuring cycle.

7. The ultrasonic measuring unit as claimed in claim 1, wherein the analysis unit is designed to receive the echoes from the same ultrasonic transducer from which the ultrasonic signals were emitted.

8. The ultrasonic measuring unit as claimed in claim 2, wherein the different channels comprise at least three channels, wherein within the measuring cycle the emitting of the successive ultrasonic signals takes place at different time intervals, wherein the different time interval for the cyclically repeated performance of the measuring cycle is constant.

9. The ultrasonic measuring unit as claimed in claim 2, wherein during the cyclically repeated performance of the measuring cycle the emitting of the successive ultrasonic signals takes place at a different time interval at least for some of the measuring cycles.

10. The ultrasonic measuring unit as claimed in claim 1, further comprising the ultrasonic transducer, wherein the ultrasonic transducer is designed to receive the echoes resulting from the ultrasonic signals on all channels and to transmit them to the analysis unit.

11. A method for operating an ultrasonic measuring unit for use in a vehicle, wherein the ultrasonic measuring unit comprises a control unit and an analysis unit, wherein the method comprises:
controlling, by way of the control unit, an ultrasonic transducer for alternately emitting ultrasonic signals on different channels,
analyzing, by way of the analysis unit, echoes resulting from the ultrasonic signals on the channels for detecting at least one object causing the echoes.

12. A computer-readable storage medium comprising computer-executable code, wherein the computer-executable code is executable by at least one processor of a computer device to cause the computer device to perform the method as claimed in claim 11.
